(19) United States
(12) Patent Application Publication
(10) Pub. No.: US 2004/0251360 A1
(43) Pub. Date: Dec. 16, 2004

(54) Apparatus

(76) Inventors: Gary David Everson, Queensland (AU); Haley Michael Patrick Connors, Queensland (AU)

Correspondence Address: Fulbright & Jaworski, 865 South Figueroa Street, Twenty Ninth Floor, Los Angeles, CA, 90017-2571, US

(21) Appl. No.: 10/399,115

(22) PCT Filed: Oct. 16, 2001
(86) PCT No.: PCT/AU01/01297

(30) Foreign Application Priority Data
Oct. 17, 2000 (AU) PR 0822

(51) Int. Cl. B02C 4/28; B02C 4/30; B02C 4/20

(52) U.S. Cl. 241/294

(57) ABSTRACT

A crushing roll which has teeth which are replaceable on the roll body, and where are the teeth or picks can be removed individually from the periphery of the roll body. The picks can be attached to a holder, and the holder can be removably attached to the roll such that the picks and the holder can be removed from the roll in an individual manner. The holder can be designed to also protect the surface of the roll to reduce damage to the roll surface.

### FIELD OF THE INVENTION

This invention is directed to an apparatus and is particularly directed to an apparatus which comprises a roll having replaceable picks and which finds particular use in the crushing industry.

### BACKGROUND ART

Crushing rolls are widely used to crush rock, coal and other solid material into smaller pieces. The rolls typically have a peripheral surface formed with an array of spaced apart picks or teeth. These picks or teeth can be hardened to improve their life. The rolls can comprise a number of removable smaller width rolls which are mounted to a common axis to form a longer roll.

It is necessary to replace the picks or teeth from time to time due to wear and tear on the roller. To date, it has been necessary to remove the smaller width rolls from the common axis and to replace the picks or teeth on a damaged roll. Some rolls have pick teeth which are removably attached to a holder. However, the holder is usually welded or otherwise rigidly fixed to the roll. Should the holder becoming damaged, the entire roll needs to be removed and repaired. If a roll is made up of several smaller width rolls, it is often found that the more central rolls experience greater wear and tear on the pick teeth. To date, it has been a time-consuming task to stop the roll, to remove the outer smaller width rolls, remove the central damaged roll, and to repeat the entire process with a repaired roll.

Another disadvantage with existing rolls is the damage which can occur on the periphery of the roll body. That is, conventional rolls have hardened teeth attached to a holder, with the holder being welded or otherwise attached to the periphery of the roll body. The periphery of the roll body is exposed to the material to be crushed, and if this material is unusually hard, damage will occur to the outer periphery of the roll. Thus, it may become necessary to replace an entire roll, not necessarily due to damage to the pick or the holder, but due to damage to the periphery of the roll body.

### OBJECT OF THE INVENTION

The present invention is directed to a roll which has teeth which are replaceable on the roll body, and where are the teeth or picks can be removed individually from the periphery of the roll body. The picks can be attached to a holder, and the holder can also be removably attached to the roll such that the picks and the holder can be removed from the roll in an individual manner. The holder can be designed to also protect the surface of the roll to reduce damage to the roll surface.

In one form, the invention resides in a roll having replaceable pick teeth, the roll comprising, a roll body having a peripheral surface, at least one cavity in the surface, a pick tooth assembly adapted for removable attachment to the roll, the assembly comprising, a pick tooth, a holder for the pick tooth, the holder having a main body portion which is at least partially insertable into the cavity, and, releasable locking means to lock the holder in the cavity.

The roll is typically annular in configuration having an outer peripheral surface and an internal through bore to allow the roll to be mounted onto a shaft or axle. The roll can have various configurations and sizes. For use as a crushing roll, the roll typically has a diameter of between 60 cm-200 cm, and a width (or length) of between 10 cm-100 cm. The roll may be formed of steel, cast-iron or other suitable materials. It should be appreciated that the roll need not have a through bore and may comprise a solid body, or a hollow closed cylindrical body which is mounted for rotation.

The roll has at least one cavity in the peripheral surface. The cavity is preferably configured to accommodate the pick tooth holder. It is preferred that each pick tooth is removably attached to the roll, and therefore it is preferred that the roll is provided with a plurality of cavities to accommodate a plurality of holders. It is preferred that one cavity will accommodate one pick tooth holder, although it is envisaged that a cavity may be dimensioned to accommodate more than one holder.

The cavity may comprise an entry slot having a smaller size, and a main cavity area extending below the slot and having a larger size. This configuration can facilitate attachment of the holder into the cavity.

A pick tooth assembly is provided. The pick tooth assembly is adapted for removable attachment to the roll. It is preferred that the roll has each pick tooth removably attachable. The assembly comprises a pick tooth. The pick tooth may be of conventional manufacture and typically comprises a hardened forward tooth head, and a rearwardly extending shaft or spigot. The tooth head may be tapered, conical, or frusto-conical. Other tooth head shapes are envisaged.

The assembly further comprises a holder for the pick tooth. The holder may have a bore which accommodates the shaft or spigot of the pick tooth. The holder has a main body portion which is at least partially insertable into the cavity. This main body portion may be substantially solid and is typically formed of steel. The main body portion may have a cross-section which approximates the cross-section of the cavity. The main body portion may be substantially block-like in configuration and may have a substantially planar rear wall, a substantially planar boss on the wall, opposed substantially planar side walls, and a front wall which has a curved nose portion. It is preferred that the rear wall of the main body portion is spaced inwardly from the corresponding wall in the cavity. This allows the holder to be quite easily inserted into and removed from the cavity.

The holder may have a top wall which may be curved to be in line with the curvature of the outer periphery of the roll. The top wall may comprise other shapes and configurations as well. The top wall can have an extending part which comprises a wear plate. The wear plate can extend over a part of the periphery of the roll to protect the roll against damage. The wear plate may be provided with a recess in a front portion. The function of the recess may be to assist in the removal of the holder from the cavity. This will be described in greater detail below.

It is preferred that the roll is provided with an array of cavities which accommodate the holder, and that the wear plate on each holder is configured such that when all the holders are fitted into the cavities, the wear plates form a substantially continuous armoured protective plate array about the periphery of the roll.

A releasable locking means is provided to lock the holder in the cavity. The releasable locking means may comprise an insert block or member. The block or member may be formed of steel or other suitable material. It is preferred that the insert block or member has a configuration to allow it to fit between the rear wall of the holder, and the corresponding wall of the cavity to assist in locking the holder into the cavity. The insert block or member may have a small extending lip which extends over the periphery of the roll immediately adjacent the cavity. The lip may function to assist in levering out the insert block to change the pick tooth.

The insert block may have a tapering portion, and an adjacent wall of the holder may also be tapered to facilitate locking of the insert block relative to the holder. The degree of taper can vary but is typically approximately 6°.

The tapering portion on the insert block and the holder may be provided with grip enhancing means. The grip enhancing means may comprise ribs, projections, buttons, teeth and the like and suitably comprise an array of spaced apart parallel ribs which can engage with corresponding grooves to facilitate locking of the insert block to the holder.

A biasing means may be provided to hold the locking means in place and/or to bias the holder into engagement with walls of the cavity. The biasing means may bias the insert block or member which in turn creates a bias against the holder. The biasing means may comprise a compressible member. A suitable compressible member may comprise a rubber member. The rubber member may be in the form of a rubber rod or key. A complimentary configured recess may be provided in the insert block or member to accommodate the rubber member.

### BRIEF DESCRIPTION OF THE DRAWINGS

Embodiments of the invention will be described with reference to the following drawings in which:

FIG. 1 illustrates the various parts of the invention.

FIG. 2 illustrates a roll showing an array of cavities in the roll and one pick tooth assembly fitted into one cavity.

FIG. 3 Illustrates In section view a close-up of the pick tooth assembly.

FIG. 4 - cancelled.

FIG. 5 illustrates the various parts of the invention according to a second embodiment.

FIG. 6 illustrates a roll showing an array of cavities in the roll and one pick tooth assembly according to the second embodiment fitted into one cavity.

FIG. 7 Illustrates in section view a close-up of the pick tooth assembly according to the second embodiment.

### BEST MODE

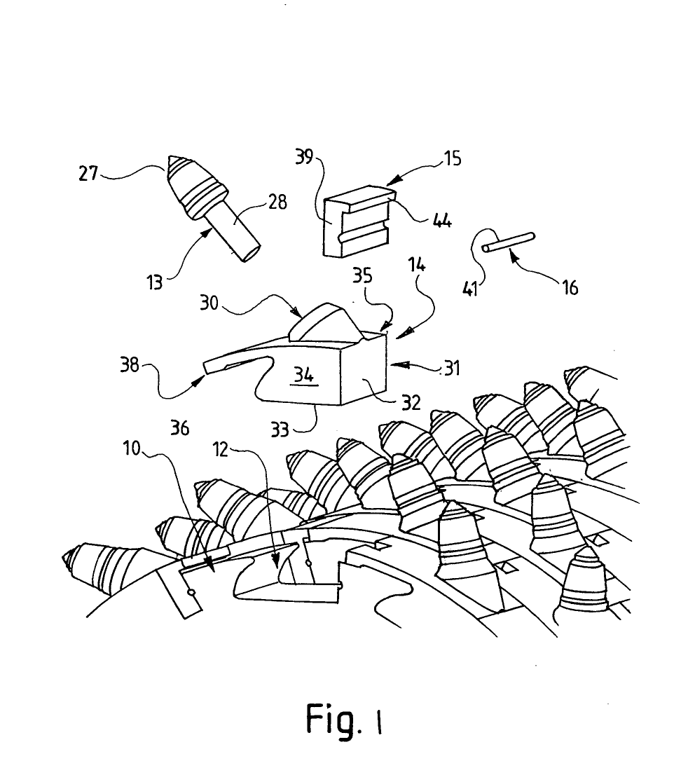

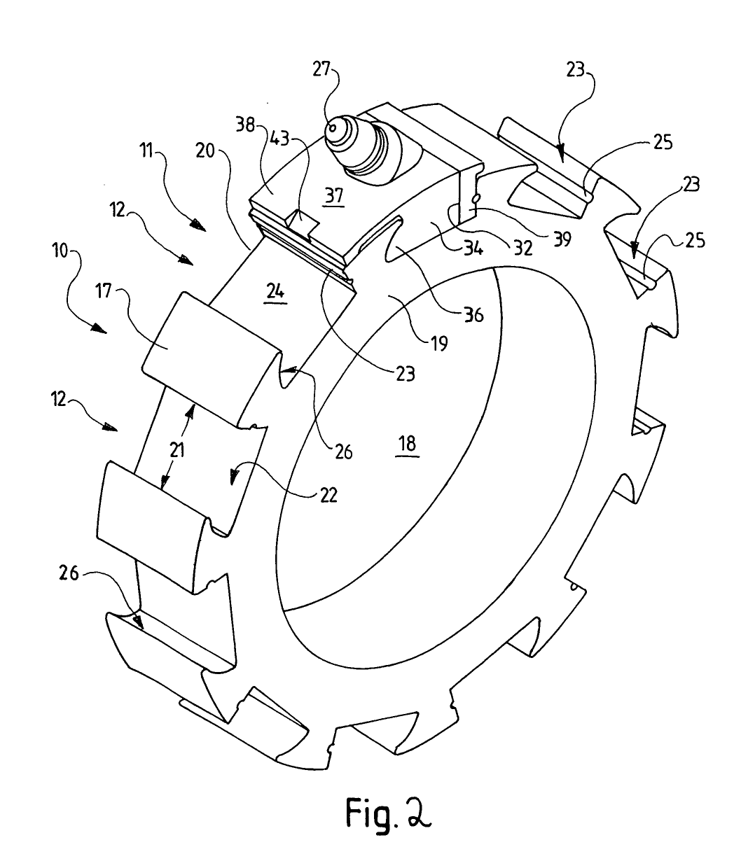

Referring to the drawings and initially to FIG. 1 there is illustrated the various components of an embodiment of the invention. Specifically, FIG. 1 illustrates a roll 10 comprising a roll body 11 having a peripheral surface formed with an array of cavities 12 in the surface of the roll. A pick tooth assembly is illustrated which comprises the following components - a pick tooth 13, a holder 14 and a releasable locking means 15. A biasing means 16 is also illustrated.

Referring in greater detail to the roll 10, and referring to FIGS. 2, there is illustrated a roll 10. Roll 10 is annular in configuration and comprises a peripheral surface 17, an internal through bore 18 and planar side walls 19, 20. Internal through bore 18 allows roll 10 to be mounted to a shaft for rotation with a number of adjacent rolls. This arrangement is best illustrated in FIG. 1. Roll 10 is formed with an array of equally spaced apart cavities 12. Cavities 12 have a smaller sized entry slot 21 which leads into a larger size main cavity area 22. The cavities are identically shaped relative to each other and are spaced equally about the periphery of the roll in the embodiment illustrated in FIG. 2, there are eleven equally spaced apart cavities. This can of course vary depending on the size of the roll. Each cavity has a planar rear wall 23, and a planar bottom wall 24. Rear wall 23 is provided with a transverse recess 25 to accommodate the biasing means 16 which will be described in greater detail below. Each cavity has a curved front wall 26 which forms an undercut in the roll.

A pick tooth assembly is provided which fits into each cavity 12. The pick tooth assembly comprises a pick tooth 13. Pick tooth 13 can be of conventional manufacture and such a tooth is known in the art the tooth 13 has a hardened rounded tooth head 27 and a rearwardly extending shaft or spigot 28.

A holder 14 is provided to accommodate the pick tooth 13. Holder 14 has an internal angled bore 30 to accommodate shaft 28. The bore is angled such that the pick tooth extends at an angle to the periphery of the roll. Holder 14 has a main body portion 31 which is block like in configuration and contains bore 30.

Main body portion 31 has a planar rear wall 32, a planar bottom wall 33 and opposed planar side walls 34, 35. The main body portion has a front wall which has a curved nose portion 36. The configuration of the main body portion is such that it fits within a respective cavity 12 such that the curved nose portion 36 fits within the front wall 26 of cavity 12, bottom wall 33 sits on top of bottom wall 24 of the cavity, and the opposed side walls 34, 35 are flush with the side walls 19, 20 of roll 10. However, the size of the main body portion is such that rear wall 32 is spaced away from rear wall 23 of cavity 12.

Holder 14 has a curved top wall 37 which has a degree of curvature which corresponds to the curvature of roll 10. Extending from a front edge of the curved top wall 37 is a wear plate 38. Wear plate 38 is an integral extension of top wall 37. The entire holder is typically formed of steel. Wear plate 38 thus forms a steel armour plating over the periphery of roll 10. The front of wear plate 38 is formed with a recess or notch 43 the reason of which will be described in greater detail below.

A locking means is provided to lock the holder into the cavity. In the embodiment, the locking means is in the form of an insert block 39. Insert block 39 is formed of steel and has a rectangular main body portion and a integrally formed return lip 44 extending from a top edge of main body portion 40. Insert block 39 fits between n rear wall 32 of main body portion 31 of the holder, and rear wall 25 of the cavity 12, and can be pushed or hammered into place. Once fitted, the insert block ensures that the front nose portion 36 of holder 14 is in the curved front wall 26 of cavity 12. As well, holder 12 cannot be readily removed from the cavity.

A biasing means 16 is provided to ensure that the insert block 39 is pushed up against holder 14 to lock the components in place. The biasing means is in the form of a compressible rubber rod 41. Rod 41 fits into recess 25 of the rear wall of cavity 12 and the insert block 39 is also formed with an elongate recess 42 to accommodate rubber rod 41. The recesses are sufficiently shallow such that the rod 41 can function to bias insert block 39 against holder 14 and to hold the insert block in place.

In use, pick tooth 13 is initially inserted into the bore 30. Rubber rod 41 is fitted to the insert block 39. The tooth holder with the assembled tooth is then placed in cavity 12. Once in this position, insert block 39 is then pushed or hammered into the space between holder 14 and the rear wall of the cavity. Rubber rod 41 constrains the insert block vertically.

To remove the holder, a tool is inserted into notch 43 and thus underneath lip 44 of insert block 39. The tool can then be levered to pull out insert block 39. Once the insert block has been removed, holder 14 can be removed from cavity 12.

As illustrated in FIG. 1, the configuration of each cavity, and the configuration of each holder and particularly each wear plate 38 is such that the front of wear plate 38 of one holder abuts against the rear of an adjacent holder. This provides a continuous armour plating about the periphery of the roll.

Referring to FIGS. 5-7 there is illustrated a second embodiment of the invention, the main difference being in the shape in configuration of the pick tooth assembly. Referring to the drawings and initially to FIG. 7 there is illustrated the various components of this embodiment of the invention. Specifically, FIG. 7 illustrates a roll 50 comprising a roll body 51 having a peripheral surface formed with an array of cavities 52 in the surface of the roll. A pick tooth assembly is illustrated which comprises the following components—a pick tooth 53, a holder 54 and a releasable locking means 55. A biasing means (not illustrated) may also be present.

Roll 50 is formed with an array of equally spaced apart cavities 52 (see FIG. 6). Cavities 52 have a smaller sized entry slot 61 which leads into a larger size main cavity area 62. The cavities are identically shaped relative to each other and are spaced equally about the periphery of the roll. In the embodiment illustrated in FIG. 6, there are ten equally spaced apart cavities. This can of course vary depending on the size of the roll.

Each cavity has a planar rear wall 63, and a planar bottom wall 64. Rear wall 63 is provided with a transverse recess 65 to accommodate a biasing means (not illustrated). Each cavity has a curved front wall 66 which forms an undercut in the roll.

A pick tooth assembly is provided which fits into each cavity 52. The pick tooth assembly (see FIG. 5,6,7) comprises a pick tooth 53. Pick tooth 13 can be of conventional manufacture and such a tooth is known in the art. The tooth 53 has a hardened rounded tooth head and a rearwardly extending shaft or spigot 68.

An annular collar or ring 100 is attached to the base of spigot 68 and functions to hold the pick tooth in holder 54. Ring 100 is provided with extending projections 101 to facilitate holding of the pick tooth in holder 54.

A holder 54 is provided to accommodate the pick tooth 53. Holder 54 has an internal bore 70 (see FIG. 5) to accommodate spigot 68. The bore is angled such that the pick tooth extends at an angle to the periphery of the roll. Holder 54 is block like in configuration and contains bore 70.

Holder 54 has a planar rear wall 72, a planar bottom wall 73 and opposed planar side walls 74, 75. Holder 54 has a front wall which has a curved nose portion 76. The configuration of the holder is such that it fits within a respective cavity 52 such that the curved nose portion 76 fits within the front wall 66 of cavity 52, bottom wall 73 sits on top of bottom wall 64 of the cavity, and the opposed side walls 74, 75 are flush with the side walls 59, of roll 50. However, the size of the main body portion is such that rear wall 72 is spaced away from rear wall 63 of cavity 52.

Illustrated in FIG. 5, rear wall 72 is provided with longitudinal parallel spaced apart automating ribs and grooves 102. As well, rear wall 72 is slightly tapered by about 6° this being best illustrated in FIG. 5.

Holder 54 has a curved top wall 77 (FIG. 6) which has a degree of curvature which corresponds to the curvature of roll 50. Extending from a front edge of the curved top wall 77 is a wear plate 78. Wear plate 78 is an integral extension of top wall 77. The entire holder is typically formed of steel. Wear plate 78 thus forms a steel armour plating over the periphery of roll 50. The front of wear plate 78 is formed with a recess or notch 83 (FIG. 6) the reason of which will be described in greater detail below.

A locking means is provided to lock the holder into the cavity. In this embodiment, the locking means is in the form of an insert block 79. Insert block 79 is formed of steel and has a rectangular main body portion and a integrally formed return lip 84 extending from a top edge. Insert block 79 fits between rear wall 72 of the holder, and rear wall 63 of the cavity 52, and can be pushed or hammered into place. Once fitted, the insert block ensures that the front nose portion 76 of holder 54 is in the curved front wall 66 of cavity 52. As well, holder 52 cannot be readily removed from the cavity.

The insert block 79 has a front face 105 which contacts rear wall 72 of the holder and a rear face 106 which presses up against rear wall 63 of the cavity 52. Front face 105 is formed with vertically extending spaced apart parallel ribs and grooves which makes it with the ribs and grooves which are on rear wall 72 of the holder. As well, front face 1005 is tapered by approximately 6°. This arrangement facilitates locking of holder 54 in place in the cavity.

A biasing means (not illustrated) can be provided to ensure that the insert block 79 is pushed up against holder 54 to lock the components in place. The biasing means can fit into recess 65.

1. A roll having replaceable pick teeth, the roll comprising a roll body having a peripheral surface, at least one cavity in the surface, a pick tooth assembly adapted for removable attachment in the cavity, the pick tooth assembly comprising a pick tooth, a holder for the pick tooth, the holder being at least partially insertable into the cavity, and releasable locking means to lock the holder in the cavity, the releasable locking means being separate from the holder.

2. The roll of claim 1 which has a plurality of said cavities to accommodate a plurality of said holders.

3. The roll of claim 2, wherein the cavity has an entry slot having a smaller size, and a main cavity area extending below the slot and having a larger size.

4. The roll of claim 3, wherein the pick tooth assembly comprises a holder which is formed with a bore, the pick tooth being provided with a shaft which extends into the bore.

5. The roll of claim 4, wherein the holder has a main body portion which is at least partially insertable into the cavity, the main body portion having a cross-section which approximates the cross-section of the cavity, the main body portion being substantially block-like in configuration and having a substantially planar rear wall, a curved top wall, opposed substantially planar side walls, and a front wall which has a curved nose portion, the rear wall of the main body portion being spaced inwardly from a corresponding rear wall in the cavity.

6. The roll of claim 5, wherein the top wall has an extending wear plate which extends over a part of the periphery of the roll to protect the roll against damage.

7. The roll of claim 1, wherein the releasable locking means comprises an insert block which fits between the rear wall of the holder and the corresponding wall of the cavity to assist in locking the holder into the cavity.

8. The roll of claim 7, wherein the insert block or member has a small lip which extends over the periphery of the roll immediately adjacent the cavity the lip functioning to assist in levering out the insert block to change the pick tooth.

9. The roll of claim 7, wherein the insert block has a tapering portion, an adjacent wall of the holder being tapered to facilitate locking of the insert block relative to the holder.

10. The roll of claim 1, comprising a biasing member to hold the locking means in place.

11. The roll of claim 10, wherein the biasing means comprises a compressible member which is positioned between the locking means and the holder.

12. A pick tooth assembly releasably attachable into a cavity on a crusher roll, the pick tooth assembly comprising a pick tooth, a holder for the pick tooth, the holder being at least partially insertable into the cavity, and releasable locking means to lock the holder in the cavity.

13. The assembly of claim 12, wherein the holder is formed with a bore, the pick tooth being provided with a shaft which extends into the bore.

14. The assembly of claim 13, wherein the holder has a main body portion which is at least partially insertable into the cavity, the main body portion having a cross-section which approximates the cross-section of the cavity, the main body portion being substantially block-like in configuration and having a substantially planar rear wall, a curved top wall, opposed substantially planar side walls, and a front wall which has a curved nose portion, the rear wall of the main body portion being spaced inwardly from a corresponding rear wall in the cavity.
